(19) United States
(12) Patent Application Publication
(10) Pub. No.: US 2019/0317502 A1
(43) Pub. Date: Oct. 17, 2019

(54) METHOD, APPARATUS, DEVICE, AND SYSTEM FOR CONTROLLING UNMANNED AERIAL VEHICLE

(71) Applicant: SZ DJI TECHNOLOGY CO., LTD., Shenzhen (CN)

(72) Inventors: Zhuo GUO, Shenzhen (CN); Peiliang LI, Shenzhen (CN)

(21) Appl. No.: 16/428,247

(22) Filed: May 31, 2019

Related U.S. Application Data
(63) Continuation of application No. PCT/CN2016/108260, filed on Dec. 1, 2016.

(51) Int. Cl. G05D 1/00; B64C 39/02

(52) U.S. Cl. CPC G05D 1/0094; G05D 1/0022; B64C 2201/127; B64C 2201/146; B64C 2201/123; B64C 39/024

(57) ABSTRACT

A method for controlling an unmanned aerial vehicle (“UAV”) includes detecting a first operation on an interactive interface. The method also includes determining a flight mode of the UAV triggered by the first operation, and controlling the UAV to fly in the flight mode.

### CROSS-REFERENCE TO RELATED APPLICATION

This application is a continuation application of International Application No. PCT/CN2016/108260, filed on Dec. 1, 2016, the entire contents of which are incorporated herein by reference.

### TECHNICAL FIELD

The present disclosure relates to the technology field of unmanned aerial vehicles and, more particularly, to a method, an apparatus, a device, and a system for controlling an unmanned aerial vehicle (“UAV”).

### BACKGROUND

In real-world applications, such as surveillance, search, and photographing tasks, sometimes it is necessary to detect and track one or multiple objects. Unmanned aerial vehicles (“UAVs”) carrying a payload (e.g., a camera) may be used to track the objects, or may be controlled to move in a certain direction. Tracking and/or flight navigation methods may be based on global positioning system data or camera vision. However, practical applications of tracking and/or navigation are hindered due to the lack of easy-to-use interactive control and guidance system. Currently, an operator needs to manually select a target object, and manually control the UAV/camera to move to the target object or to follow the target object. The conventional control methods are complex. In addition, the conventional control methods place a high requirement on the operator. Currently, there is no easy-to-use interactive system for controlling the UAVs.

### SUMMARY

In accordance with an aspect of the present disclosure, there is provided a method for controlling an unmanned aerial vehicle (“UAV”). The method includes detecting a first operation on an interactive interface. The method also includes determining a flight mode of the UAV triggered by the first operation, and controlling the UAV to fly in the flight mode.

In accordance with another aspect of the present disclosure, there is also provided a device for an unmanned aerial vehicle (“UAV”). The device includes an interactive interface configured to detect a first operation. The device also includes a processor configured to determine a flight mode of the UAV triggered by the first operation and to control the UAV to fly in the flight mode.

The present disclosure provides a method, an apparatus, a device, and a system for controlling UAVs. The disclosed method may include detecting a first operation on an interactive interface, selecting a flight mode for the UAV based on the first operation, and controlling the UAV to fly in the flight mode triggered by the first operation. The disclosed method, apparatus, device, and system overcome disadvantages of conventional method, apparatus, device, and system that require manual operations to control the UAV to fly in the selected flight mode. In the disclosed technical solutions, the operations for selecting the flight mode for the UAV are simplified. Accordingly, the operation efficiency of controlling the UAV is improved.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a schematic diagram of an unmanned flight system, according to an example embodiment.

FIG. 2 is a flow chart illustrating a method of controlling a UAV, according to an example embodiment.

FIG. 3 is a schematic illustration of a method of controlling the UAV to fly in horizontally circling tracking flight mode, according to an example embodiment.

FIG. 4 is a schematic illustration of a second operation, according to an example embodiment.

FIG. 5 is schematic illustration of a method of controlling the UAV to fly in a vertically circling tracking flight mode, according to an example embodiment.

FIG. 6 is a schematic illustration of a second operation, according to another example embodiment.

FIG. 7 is a schematic illustration of a method of controlling the UAV to fly in a moving-away or moving-closer tracking flight mode, according to an example embodiment.

FIG. 8 is a schematic illustration of a second operation, according to another example embodiment.

FIG. 9 is a schematic illustration of a second operation, according to another example embodiment.

FIG. 10 is a schematic illustration of a method of controlling the UAV to fly in an image composition adjusting tracking flight mode, according to an example embodiment.

FIG. 11 is a schematic diagram of an apparatus for controlling the UAV, according to an example embodiment.

FIG. 12 is a schematic diagram of a device for controlling the UAV, according to another example embodiment.

FIG. 13 is a schematic diagram of a system for controlling the UAV, according to an example embodiment.

### DETAILED DESCRIPTION OF THE EMBODIMENTS

Technical solutions of the present disclosure will be described in detail with reference to the drawings, in which the same numbers refer to the same or similar elements unless otherwise specified. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless.

When a first component is referred to as “disposed,” “located,” or “provided” on a second component, the first component may be directly disposed, located, or provided on the second component or may be indirectly disposed, located, or provided on the second component via an intermediate component. The term “on” does not necessarily mean that the first component is located higher than the second component. In some situations, the first component may be located higher than the second component. In some situations, the first component may be disposed, located, or provided on the second component, and located lower than the second component. In addition, when the first item is disposed, located, or provided “on” the second component, the term “on” does not necessarily imply that the first component is fixed to the second component. The connection between the first component and the second component may be any suitable form, such as secured connection (fixed connection) or movable contact.

When a first component is referred to as “disposed,” “located,” or “provided” in a second component, the first component may be partially or entirely disposed, located, or provided in, inside, or within the second component. When a first component is coupled, secured, fixed, or mounted “to” a second component, the first component may be is coupled, secured, fixed, or mounted to the second component from any suitable directions, such as from above the second component, from below the second component, from the left side of the second component, or from the right side of the second component.

The terms “perpendicular,” “horizontal,” “left,” “right,” “up,” “upward,” “upwardly,” “down,” “downward,” “downwardly,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure.

In addition, the singular forms “a,” “an,” and “the” are intended to include the plural forms as well, unless the context indicates otherwise. And, the terms “comprise,” “comprising,” “include,” and the like specify the presence of stated features, steps, operations, elements, and/or components but do not preclude the presence or addition of one or more other features, steps, operations, elements, components, and/or groups. The term “and/or” used herein includes any suitable combination of one or more related items listed. For example, A and/or B can mean A only, A and B, and B only. The symbol “/” means “or” between the related items separated by the symbol. The phrase “at least one of” A, B, or C encompasses all combinations of A, B, and C, such as A only, B only, C only, A and B, B and C, A and C, and A, B, and C.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

The following descriptions explain example embodiments of the present disclosure, with reference to the accompanying drawings. Unless otherwise noted as having an obvious conflict, the embodiments or features included in various embodiments may be combined.

The following embodiments do not limit the sequence of execution of the steps included in the disclosed methods. The sequence of the steps may be any suitable sequence, and certain steps may be repeated.

The present disclosure provides a method, device, apparatus, and system for controlling a UAV. The following descriptions use UAV as an example of an unmanned vehicle. A person having ordinary skill in the art can appreciate that the present disclosure does not limit the unmanned vehicle to be a UAV. Other types of unmanned vehicles may also be used. In addition, the present disclosure does not limit the type of UAV. Various types of UAVs may be used. For example, the UAV may be a small or a large UAV. In some embodiments, the UAV may be a rotorcraft. In some embodiments, the UAV may be a multi-rotor UAV air-propelled by multiple propulsion devices.

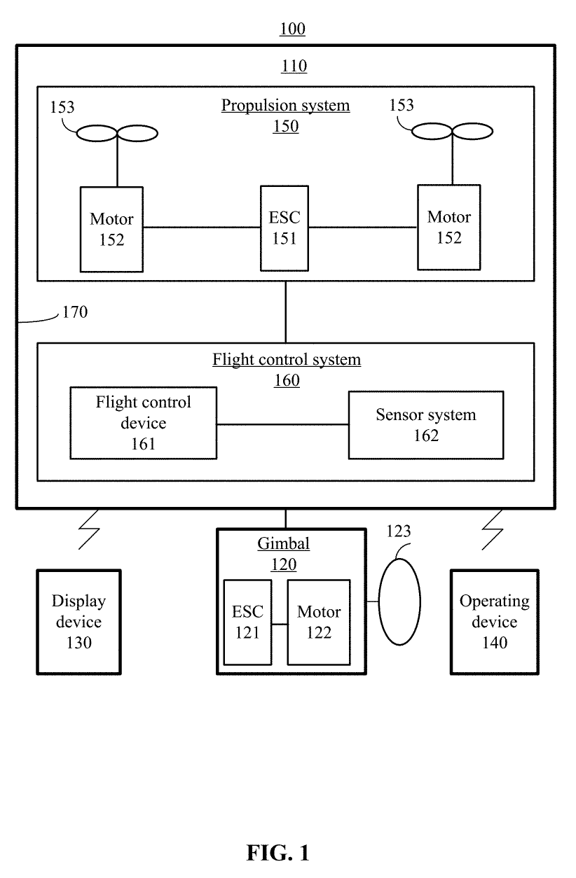

FIG. 1 is a schematic diagram of an unmanned flight system 100. In the following descriptions, the rotorcraft is used as an example of the UAV.

The unmanned flight system 100 may include a UAV 110, a gimbal 120, a display device 130, and an operating device 140. The UAV 110 may include a propulsion system 150, a flight control system 160, and an aircraft frame 170. The UAV 110 may wirelessly communicate with the operating device 140 and the display device 130.

The aircraft frame 170 may include an aircraft body and a landing stand (or landing gear). The aircraft body may include a central frame and one or more arms connected with the central frame. The one or more arms may radially extend from the central frame. The landing stand may be connected with the aircraft body to support the UAV 110 during landing.

The propulsion system 150 may include an electrical speed control (“ESC”) 151, one or more propellers 153, and one or more motors 152 corresponding to the one or more propellers 153. Each motor 152 may be mechanically and/or electrically coupled between the ESC 151 and the propeller 153. In some embodiments, the motor 152 and the propeller 153 may be mounted on a corresponding arm. The ESC 151 may be configured to receive a driving signal generated by the flight control system 160, and to provide a current for driving the motor 152 based on the driving signal, thereby controlling the rotation speed of the motor 152. The motor 152 may be configured to drive the propeller 153 to rotate, thereby providing a propulsion force for the flight of the UAV 110. The propulsion force enables the UAV 110 to move in one or more degrees of freedom. In some embodiments, the UAV 110 may rotate around one or more rotation axes. For example, the rotation axes may include at least one of a roll axis, a yaw axis, or a pitch axis. In some embodiments, the motor 152 may include a direct current motor or an alternating current motor. In some embodiments, the motor 152 may be a brushless motor or a brushed motor.

The flight control system 160 may include a flight control device 161 and a sensor system 162. The sensor system 162 may be configured to measure, obtain, or detect attitude information of the UAV 110, e.g., the spatial location information of the UAV 110 and the status information of the UAV 110, such as at least one of a three-dimensional location or position, a three-dimensional angle, a three-dimensional velocity, a three-dimensional acceleration, or a three-dimensional angular velocity. The sensor system 162 may include at least one of a gyroscope, a digital compass, an inertial measurement unit (“IMU”), a vision sensor, a global navigation satellite system, or a barometer. For example, the global navigation satellite system may include a global positioning system (“GPS”). In some embodiments, the flight control device 161 may be configured to control the flight of the UAV 110. For example, the flight control device 161 may control the flight of the UAV 110 based on the attitude information obtained by the sensor system 162. In some embodiments, the flight control device 161 may control the UAV 110 based on pre-programmed computer codes or instructions. In some embodiments, the flight control device 161 may control the UAV 110 based on one or more commands or instructions received from the operating device 140.

The gimbal 120 may include an ESC 121 and a motor 122. The gimbal 120 may be configured to carry an imaging device 123. The flight control device 161 may control the motion of the gimbal 120 through the ESC 121 and the motor 122. In some embodiments, the gimbal 120 may include a controller configured to control the motion of the gimbal 120 through the ESC 121 and the motor 122. In some embodiments, the gimbal 120 may be independent of the UAV 110, or may be part of the UAV 110. In some embodiments, the motor 122 may be a direct current motor or an alternating current motor. The motor 122 may be a brushless motor or a brushed motor. In some embodiments, the gimbal 120 may be disposed at a top portion of the UAV 110 or at a lower portion of the UAV 110.

The imaging device 123 may include any device for capturing images, such as at least one of a camera or a camcorder. The imaging device 123 may communicate with the flight control device 161 and may capture images under the control of the flight control device 161.

The display device 130 may be located at a ground terminal of the unmanned flight system 100, and may be configured to wirelessly communicate with the UAV 110. The display device 130 may display the attitude information of the UAV 110. In some embodiments, the display device 130 may be configured to display images captured by the imaging device 123. The display device 130 may be an independent device, or may be part of the operating device 140.

The operating device 140 may be located at the ground terminal of the unmanned flight system 100, and may be configured to wirelessly communicate with the UAV 110 to control the UAV 110 remotely. The operating device 140 may include a remote control device or a user terminal installed with an application (or “App”) for controlling the UAV 110. In some embodiments, the user terminal may include a touch screen, through which the user may input commands or instructions for controlling the flight of the aircraft or for controlling the imaging device. A control device (e.g., the operating device 140) may include at least one of a remote control device, a laptop, a smart phone, a tablet, a ground control terminal, a smart watch, a smart wrist band, etc. In some embodiments, the operating device 140 may receive an input from a user through an input device, such as a wheel, a button, a key, or a joystick, to control the UAV 110. In some embodiments, the operating device 140 may receive an input from the user through a user interface (“UI”) provided at the user terminal to control the UAV 110.

The names of various parts of the unmanned flight system are only intended for identifying the various parts, and are not intended to limit the scope of the present disclosure.

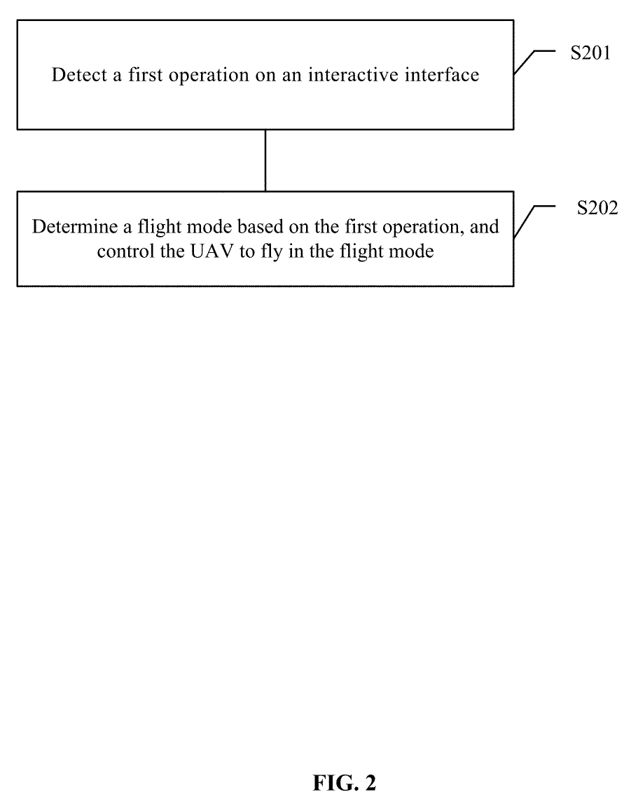

FIG. 2 is a flow chart illustrating a control method for controlling a UAV. The control method of FIG. 2 may include the following steps.

Step S201: detecting a first operation on an interactive interface.

In some embodiments, the interactive interface is an integral part of the control device, which may be an interface for interacting with a user. A user may control the UAV through operations performed on the interactive interface. In some embodiments, the interactive interface may be configured to display all or some parameters relating to the flight of the UAV, and to display images captured by the UAV. When a user desires to control the flight of the UAV, the user may operate the interactive interface of the control device. The control device may detect the operations of the user through the interactive interface. In some embodiments, when the user wishes to select the flight mode of the UAV, the user may perform a first operation on the interactive interface. The interactive interface may detect the first operation. In some embodiments, the control device discussed herein may be the operating device 140.

Step S202: determining a flight mode of the UAV triggered by the first operation, and controlling the UAV to fly in the flight mode.

In some embodiments, the UAV may have a plurality of flight modes, such as pointing flight mode, tracking flight mode, etc. In the different flight modes, the flight paths of the UAV, the control methods of the UAV, and the functions realized by the UAV may be different. A user may perform the first operation through the interactive interface to select different flight modes. In some embodiments, the first operation may include various types of operations. Various types of operations may correspond to different flight modes. When the interactive interface detects the first operation, the control device may determine the flight mode of the UAV based on the detected first operation, and may control the UAV to fly in the flight mode corresponding to the first operation.

In some embodiments, in the disclosed control method for controlling the UAV, the first operation may be detected by the interactive interface, and the UAV may be controlled to fly in a flight mode determined based on the first operation. The disclosed method avoids complex operations for controlling the UAV to fly in a selected mode, in which the user has to first perform an operation to retrieve and display all of the flight modes of the UAV, and then perform another operation to select a flight mode and click to confirm. The disclosed method overcomes disadvantages of conventional techniques that require multiple manual operations in order to control the UAV to fly in the selected flight mode. When compared to the conventional techniques, the disclosed method simplifies the operations for selecting a flight mode for the UAV, and increases the efficiency of controlling the UAV.

Alternatively or additionally, in some embodiments, when the first operation is a touching-point operation, the flight mode triggered by the first operation may be a pointing flight mode. The pointing flight mode may be configured to instruct the UAV to fly in a direction indicated by the touching-point operation in the image to be captured. Controlling the UAV to fly in the flight mode may include controlling the UAV to fly in the pointing flight mode.

In some embodiments, the interactive interface may detect a pressing or touching of a finger of a user. When the operation is a touching-point operation, i.e., when a finger of the user presses or touches the interactive interface that displays the image to be captured, the interactive interface may detect the touching point. Thus, the first operation may trigger the flight mode to be a pointing flight mode. The flight direction may be determined based on the touching point of the user in the image to be captured. The UAV may fly in the flight direction determined based on the touching point, thereby realizing fixed-direction flight. This operation for controlling the flight of the UAV is simple and straightforward. In some embodiments, a user may point to a direction in the image to be captured, and the UAV may fly in that direction.

Alternatively or additionally, in some embodiments, when the first operation is a frame-drawing operation, the flight mode triggered by the first operation may be a tracking flight mode. The frame-drawing operation may be configured to select an object included in the frame (e.g., surrounded by the frame) in the image to be captured as a target object for tracking. The tracking flight mode may be configured to instruct the UAV to track the target object while flying. Controlling the UAV to fly in the flight mode may include controlling the UAV to track the target object while flying in the tracking flight mode.

In some embodiments, the interactive interface may detect a touching of a finger of the user. When the operation is a frame-drawing operation, i.e., when a user uses a finger to press or touch the interactive interface that displays the image to be captured, and drags the finger while maintaining the pressing or touching, a rectangular frame may be displayed on the interactive interface. When the rectangular frame surrounds (or selects) the imaging object, or when the rectangular frame covers a portion or all of the imaging object, the UAV may determine the imaging object as the target object to be tracked. The UAV may start tracking the target object while flying. In the meantime, the UAV may capture images of the target object using the imaging device carried by the UAV.

Alternatively or additionally, in some embodiments, after executing step S201, the method may further include detecting a second operation on the interactive interface. The second operation may be used to determine a sub-flight mode of the tracking flight mode of the UAV. Controlling the UAV to track the target object while flying in the tracking flight mode may include controlling the UAV to track the target object while flying in the sub-flight mode of the tracking flight mode.

In some embodiments, when the user selects the target object using the frame drawn by the first operation, the UAV may track the target object while flying. The UAV may change its location as the target object moves, thereby realizing tracking of the target object. In some embodiments, the tracking flight mode may include multiple sub-flight modes. Each of the sub-flight modes may achieve different functions in the tracking flight mode. A user may select a sub-flight mode of the tracking flight mode through a second operation on the interactive interface. The disclosed method may enable the UAV to achieve the specific function of the sub-flight mode while maintaining the tracking of the target object. When the interactive interface detects the second operation performed by the user, the control device may control the UAV based on the sub-flight mode of the tracking flight mode triggered by the second operation. In some embodiments, when the interactive interface detects the second operation, the UAV may fly in the sub-flight mode of the tracking flight mode triggered by the second operation, until a signal terminating the sub-flight mode is received. In some embodiments, when the interactive interface detects the second operation, the UAV may fly in the sub-flight mode of the tracking flight mode triggered by the second operation, and may change its location in the air during the process of the second operation, until the second operation stops or fails.

Correspondingly, in some embodiments, step S202 may be implemented using the following method: controlling the UAV to track the target object while flying in the sub-flight mode of the tracking flight mode. The sub-flight mode of the tracking flight mode may include at least one of: watching or monitoring, tracking, circling, horizontally circling tracking flight, vertically circling tracking flight, etc. The present disclosure does not limit the sub-flight mode. The disclosed method overcomes disadvantages of conventional techniques that require multiple manual operations to select a sub-flight mode of the tracking flight mode. The disclosed method simplifies the operations for selecting a sub-flight mode of the tracking flight mode, thereby increasing the efficiency of controlling the flight of the UAV.

Alternatively or additionally, in some embodiments, the sub-flight mode of the tracking flight mode may be a horizontally circling tracking flight mode. The horizontally circling tracking flight mode may be configured to instruct the UAV to use the target object as a center point, maintain a constant distance relative to the target object, and track the target object while circling around the target object in a horizontal plane. Controlling the UAV to track the target object while flying in the sub-flight mode of the tracking flight mode may include: controlling the UAV to track the target object while flying in the horizontally circling tracking mode based on a control amount generated by the second operation.

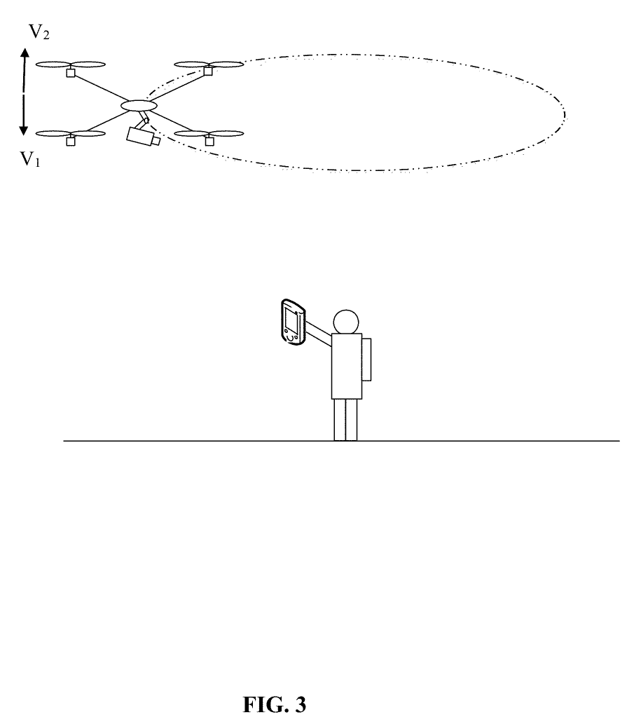

In some embodiments, when the sub-mode of the tracking flight mode is a horizontally circling tracking flight mode, i.e., when the second operation triggers the horizontally circling tracking flight mode, as shown in FIG. 3, in the horizontally circling tracking flight mode, the UAV may maintain a substantially constant distance relative to the target object. The UAV may track the target object while circling around the target object on a specific horizontal plane, e.g., flying around the target object along a circular path shown in FIG. 3. When a user performs the second operation on the interactive interface, and when the sub-flight mode of the tracking flight mode triggered by the second operation triggers is the horizontally circling tracking flight mode, the control device may convert the second operation into a corresponding control amount. The control device may transmit the control amount to the UAV. After receiving the control amount, the UAV may perform corresponding controls based on the control amount, thereby changing a location of the UAV when the UAV horizontally circles around the target object, i.e., changing the location of the UAV on the circular path. As shown in FIG. 3, the disclosed method also includes adjusting an aircraft head of the UAV or a gimbal of the UAV, such that the imaging device of the UAV points to and focuses on the target object.

Alternatively or additionally, in some embodiments, the control amount generated by the second operation may be used to control one or more of a flight velocity, a flight direction, a flight distance, or an acceleration of the UAV.

Alternatively or additionally, in some embodiments, the second operation may include at least one touching operation and a left-moving operation based on the at least one touching operation. The left-moving operation may include moving in a negative axis direction of a U axis in an image coordinate system. Controlling the UAV to fly while tracking the target object based on the horizontally circling tracking mode and based on the control amount generated by the second operation may include: based on the control amount generated by the second operation, controlling the UAV to horizontally circle around the target object using the target object as a center, in a counter-clockwise or clockwise direction.

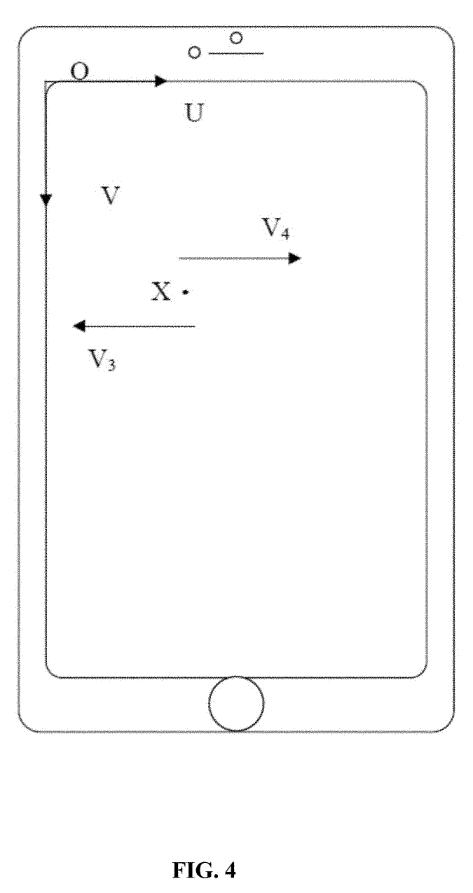

In some embodiments, when the second operation includes at least one touching operation and a left-moving operation based on the at least one touching point, i.e., when the user uses at least one finger to press or touch the interactive interface, and moves the at least one finger left while maintaining the pressing or touching, as shown in FIG. 4, in the interactive interface of the control device, based on directions defined in the image coordinate system, the left-moving operation includes moving the finger in the negative axis direction of the U axis in the image coordinate system. When a touching point X formed by the user pressing or touching the user interface moves in the negative axis direction of the U axis (the V₃ direction shown in FIG. 4), the control device may generate the corresponding control amount. The control device may transmit the control amount to the UAV. The UAV may control its flight based on the control amount. For example, the UAV may horizontally circle around the target object, using the target object as a center, in a counter-clockwise (the V₁ direction shown in FIG. 3) or clockwise direction (the V₂ direction shown in FIG. 3). The user may configure whether the UAV circle in the counter-clockwise direction or the clockwise direction, which is not limited in the present disclosure. In the disclosed method, the direction of horizontally circling flight may be controlled based on the movement direction of the finger of the user, thereby changing the location of the UAV on the circular path. In some embodiments, the left-moving is not strictly limited to moving in a direction parallel with the U axis. Any moving direction that forms an angle with the U axis that is smaller than a predetermined angle value can be regarded as a left-moving direction. The present disclosure does not limit the predetermined angle value.

Alternatively or additionally, in some embodiments, the second operation includes at least one touching-point operation and a right-moving operation based on at least one touching point. The right-moving may include moving in a positive axis direction of the U axis in the image coordinate system. In some embodiments, controlling the UAV to track the target object while flying in the horizontally circling tracking mode based on a control amount generated by the second operation may include: based on the control amount generated by the second operation, controlling the UAV to circle around the target object using the target object as a center in a clockwise or counter-clockwise direction.

In some embodiments, when the second operation includes at least one touching-point operation and a right-moving operation based on at least one touching point, i.e., when the user uses at least one finger to press or touch the interactive interface, and moves the finger toward right while maintaining the pressing or touching, as shown in FIG. 4, in the interactive interface of the control device, based on directions defined in the image coordinate system, the right-moving operation may include the finger of the user moving in the positive axis direction of the U axis in the image coordinate system. When a touching point X formed by the user pressing or touching the user interface moves in the positive axis direction of the U axis (the V₄ direction shown in FIG. 4), the control device may generate a corresponding control amount. The control device may transmit the control amount to the UAV. Based on the control amount, the UAV may control the horizontally circling flight using the target object as a center in the counter-clockwise direction (the V₁ direction shown in FIG. 3) or the clockwise direction (the V₂ direction shown in FIG. 3). The user may configure whether the UAV circle in the counter-clockwise direction or the clockwise direction, which is not limited in the present disclosure. In the disclosed method, the direction of horizontally circling flight may be controlled based on the movement direction of the finger of the user, thereby changing the location of the UAV on the circular path. In some embodiments, the right-moving is not strictly limited to moving in a direction parallel with the U axis. Any moving direction that forms an angle with the U axis that is smaller than a predetermined angle value can be regarded as a right-moving direction. The present disclosure does not limit the predetermined angle value.

Alternatively or additionally, in some embodiments, the disclosed method may include, based on the control amount generated by the second operation, controlling the UAV to horizontally circle around the target object using the target object as a center in a clockwise direction or a counter-clockwise direction until the at least one touching point stops moving. When the at least one touching point stops moving, the disclosed method may include controlling the UAV to stop the horizontal circling flight using the target object as a center in the clockwise direction or the counter-clockwise direction.

In some embodiments, the disclosed method may include displaying images captured while the UAV tracks the target object in a horizontally circling tracking mode to a user through the interactive interface.

Alternatively or additionally, in some embodiments, when controlling the UAV to track the target object while flying in a horizontally circling tracking mode, the disclosed method may also include adjusting an aircraft head of the UAV or a gimbal of the UAV, such that the imaging device of the UAV faces and focuses on the target object. In this manner, the UAV is maintained in a state in which the UAV tracks and captures images of the target object.

Alternatively or additionally, in some embodiments, the sub-flight mode of the tracking flight mode may be a vertically circling tracking flight mode. The vertically circling tracking flight mode may be configured to instruct the UAV to use the target object as a center, maintain a constant distance with the target object, and track the target object while flying in a vertical plane. In some embodiments, controlling the UAV to track the target object while flying in the sub-flight mode of the tracking flight mode may include: based on the control amount generated by the second operation, controlling the UAV to track the target object while flying in the vertically circling tracking flight mode.

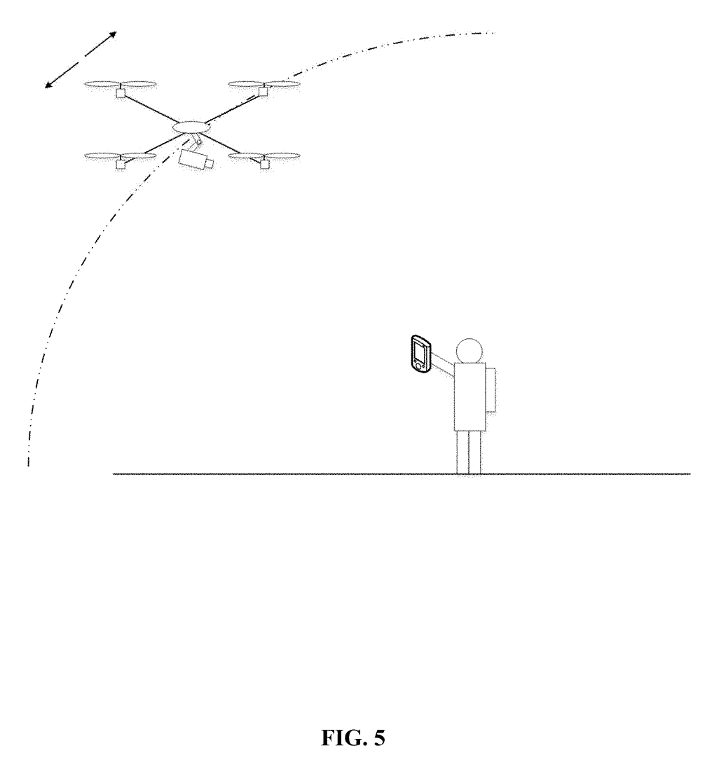

Alternatively or additionally, in some embodiments, when the sub-flight mode of the tracking flight mode is the vertically circling tracking flight mode, i.e., when the sub-flight mode triggered by the second operation is the vertically circling tracking flight mode, as shown in FIG. 5, in the vertically circling tracking flight mode, the UAV may maintain a constant distance with the target object. The UAV may track the target object while circling around the target object in a specific vertical plane. When the user performs the second operation on the interactive interface, the sub-flight mode triggered by the second operation is the vertically circling tracking flight mode. During the process of the user performing the second operation on the interactive interface, the control device may convert the second operation into a corresponding control amount. The control device may transmit the control amount to the UAV. After receiving the control amount, the UAV may perform corresponding controls based on the control amount, thereby changing the location of the UAV while the UAV circles around the user in a vertical circular arc. As shown in FIG. 5, the disclosed method may also include adjusting the aircraft head or the gimbal, such that the imaging device of the UAV faces and focuses on the target object.

Alternatively or additionally, in some embodiments, the second operation may include at least one touching-point operation and an upward-moving operation based on at least one touching point. The upward moving may include moving in a negative direction of the V axis in the image coordinate system. Based on the control amount generated by the second operation, controlling the UAV to track the target object while flying in the vertically circling tracking flight mode may include: based on the control amount generated by the second operation, controlling the UAV to circle around the target object using the target object as a center in a direction moving away from the ground.

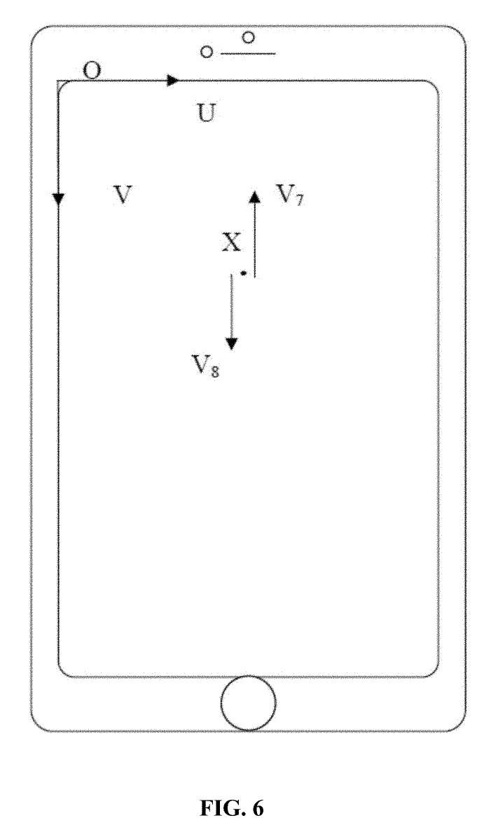

In some embodiments, when the second operation includes at least one touching-point operation and an upward-moving operation based on at least one touching point, i.e., when the user uses at least one finger to press or touch the interactive interface, and moves the finger upward while maintaining the pressing or touching, as shown in FIG. 6, in the interactive interface of the control device, based on directions defined in the image coordinate system, the upward-moving may include the finger moving in the negative direction of the V axis in the image coordinate system. When the touching point X formed by the finger of the user pressing or touching the user interface moves in the negative axis direction of the V axis (the V₇ direction shown in FIG. 6), the control device may generate a corresponding control amount. The control device may transmit the control amount to the UAV. Based on the control amount, the UAV may use the target object as a center, and circle-fly along a circular arc in a direction moving away from the ground (the V₅ direction shown in FIG. 5). In some embodiments, the upward moving is not strictly limited to moving in a direction parallel with the V axis. Any moving direction that forms an angle with the V axis that is smaller than a predetermined angle value can be regarded as an upward-moving direction. The present disclosure does not limit the predetermined angle value.

Alternatively or additionally, in some embodiments, the second operation may include at least one touching-point operation and a downward moving operation based on at least one touching point. Downward-moving may include moving in the positive axis direction of the V axis in the image coordinate system. In some embodiments, controlling the UAV to track the target object while flying in the vertically circling tracking flight mode based on the control amount generated by the second operation may include: based on the control amount generated by the second operation, controlling the UAV to circle around the target object in a direction moving closer to the ground.

In some embodiments, the second operation may include at least one touching-point operation and the downward moving operation based on the at least one touching point, i.e., when the user uses at least one finger to press or touch the interactive interface, and moves the finger downward while maintaining the pressing or touching, as shown in FIG. 6, in the interactive interface of the control device, based on the directions defined in the image coordinate system, downward moving may include the finger moving in the positive axis direction of the V axis of the image coordinate system. When the touching point X formed by the finger of the user pressing or touching the user interface moves downward (the V₈ direction shown in FIG. 6), the control device may generate a corresponding control amount. The control device may transmit the control amount to the UAV. Based on the control amount, the UAV may use the target object as a center, and circle-fly along a circular arc in a direction moving closer to the ground (the V₆ direction shown in FIG. 5). In some embodiments, the downward moving is not strictly limited to moving in a direction parallel with the V axis. Any moving direction that forms an angle with the V axis that is smaller than a predetermined angle value can be regarded as a downward-moving direction. The present disclosure does not limit the predetermined angle value.

Alternatively or additionally, in some embodiments, controlling the UAV to track the target object while flying in the vertically circling tracking flight mode includes: controlling the UAV to circle-fly to a place right over the target object in a direction moving away from the ground. In some embodiments, controlling the UAV to track the target object while flying in the vertically circling tracking flight mode includes controlling the UAV to circle-fly in a direction moving closer to the ground until the gimbal of the UAV reaches a limit position. In some embodiments, controlling the UAV to track the target object while flying in the vertically circling tracking flight mode includes controlling the UAV to circle-fly, in a direction moving closer to the ground, until a distance between the UAV and an obstacle on the ground is smaller than or equal to a first predetermined distance.

In some embodiments, in the process of controlling the UAV to fly in a direction moving away from the ground, when the UAV flies to a place right over the target object, the disclosed method may further include controlling the UAV to stop flying in the direction moving away from the ground using the target object as a center. In response to the user further moving the touching point upward, the control device does not cause the UAV to continue to move. Instead, the control device may control the UAV to remain at the place right over the target object to track the target object while flying. When the UAV uses the imaging device carried by the gimbal of the UAV to track the target object, and when the UAV flies to the place right over the target object, the pitch axis of the gimbal may rotate to a maximum rotation angle (e.g., a limit position). As a result, when the UAV passes the place right over the target object as the UAV flies from the front to the rear, the UAV may not be able to continue to track the target object.

In some embodiments, during the process of controlling the UAV to fly in a direction moving closer to the ground, when the gimbal of the UAV reaches the limit position, the disclosed method may include controlling the UAV to stop flying in the direction moving away from the ground using the target object as a center. In response to the user moving the touching point further downwardly, the control device controls the UAV to remain at the current location to track the target object while flying. In some embodiments, when a photographing angle of the imaging device carried by the gimbal is parallel with the horizontal plane, the pitch axis of the gimbal may reach a limit position with a maximum upward rotation angle. After configuring the UAV with specific settings, when the imaging device carried by the gimbal rotate upward, and when the photographing angle forms 30 degrees with respect to the horizontal plane, the pitch axis of the gimbal may reach a limit position. If the UAV continues to move in the direction moving closer to the ground after the pitch axis reaches the limit position, the imaging device of the UAV may not be able to track and capture images of the target object. During the process of controlling the UAV to fly in the direction moving closer to the ground, when detecting that the distance between the UAV and the ground or an obstacle on the ground is smaller than or equal to the first predetermined distance, there is a risk that the UAV may collide with the ground or the obstacle on the ground. At this moment, the control device may control the UAV to stop flying in the direction moving closer to the ground. In response to the user moving the touching point further downward, the control device controls the UAV to remain at the current location to track the target object while flying.

Alternatively or additionally, in some embodiments, the sub-flight mode of the tracking flight mode may be a moving-away tracking flight mode. The moving-away tracking flight mode may be configured to instruct the UAV to fly in a direction moving away from the target object. In some embodiments, controlling the UAV to track the target object while flying in the sub-flight mode of the tracking flight mode may include: based on the control amount generated by the second operation, controlling the UAV to track the target object while flying in the moving-away tracking flight mode.

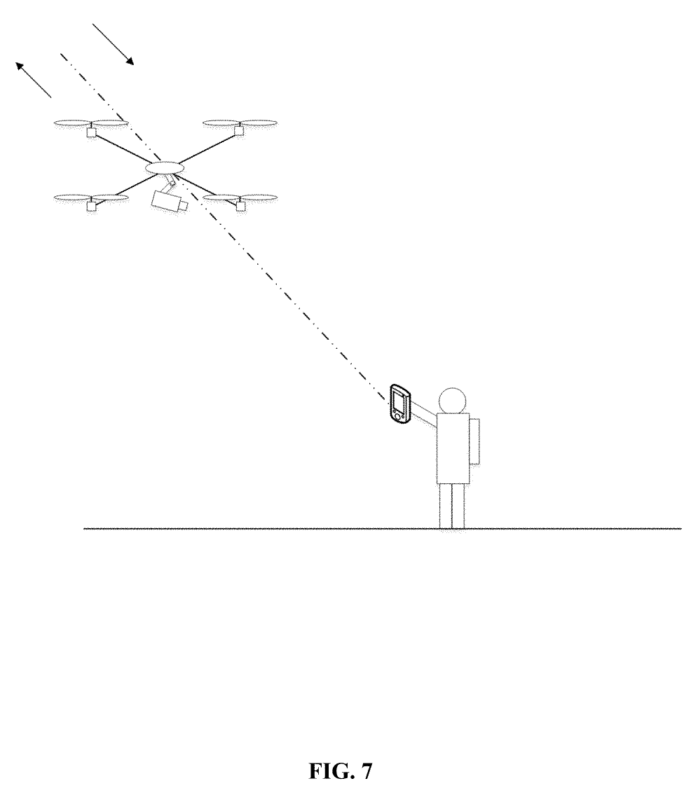

In some embodiments, the sub-flight mode of the tracking flight mode is the moving-away tracking flight mode, i.e., the sub-flight mode triggered by the second operation is the moving-away tracking flight mode. As shown in FIG. 7, in the moving-away tracking flight mode, the UAV may fly in a direction moving away from the target object while maintaining tracking of the target object. When the user performs the second operation on the interactive interface, and when the sub-flight mode of the tracking flight mode triggered by the second operation is the moving-away tracking flight mode, the control device may convert the second operation into a corresponding control amount. The control device may transmit the control amount to the UAV. After receiving the control amount, the UAV may perform corresponding controls based on the control amount to increase the distance between the UAV and the target object. As shown in FIG. 7, the disclosed method may also include adjusting the aircraft head of the UAV or the gimbal, such that the imaging device of the UAV faces and focuses on the target object.

Alternatively or additionally, in some embodiments, the second operation includes a two-touching-point operation and an opposite moving of at least one touching point toward the other touching point(s).

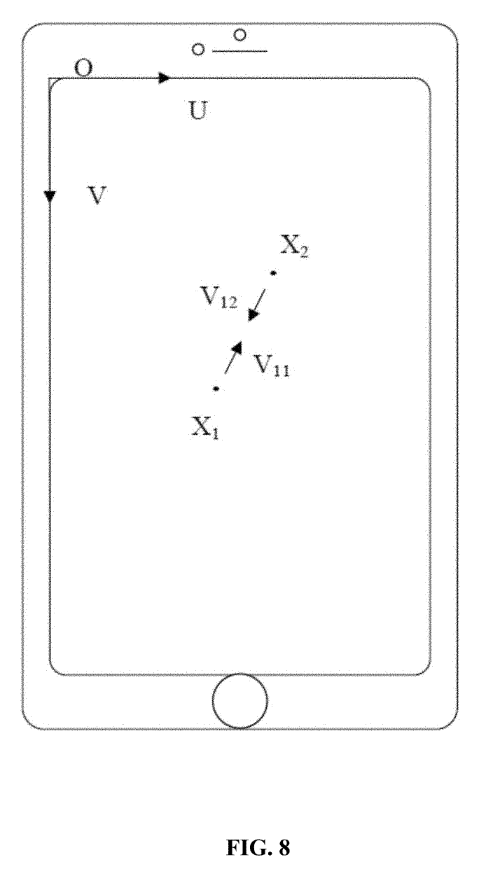

In some embodiments, the second operation includes a two-touching-point operation and an opposite moving operation of at least one touching point toward the other touching point(s). That is, when the user users a finger to press or touch the interactive interface, a touching point may be formed on the interactive interface corresponding to the finger. The second operation may include moving two fingers toward each other (i.e., opposite moving) while maintaining the finger pressing or touching of the interactive interface. As shown in FIG. 8, two touching points (X₁, X₂) formed by fingers of the user pressing or touching the interactive interface may move toward each other (as shown in V₁₁ and V₁₂ in FIG. 8). When the two touching points move closer to each other, the control device may generate a corresponding control amount. The control device may transmit the control amount to the UAV. Based on the control amount, the UAV may fly in a direction moving away from the target object (the V₉ direction shown in FIG. 7). The two touching points shown in FIG. 8 are for illustration purposes. More than two points may be used, and moving more than two touching points toward each other may realize the similar effect or function.

Alternatively or additionally, in some embodiments, the moving-away tracking flight mode may be configured to instruct the UAV to fly in a direction moving away from the target object along a line connecting the UAV and the target object.

In some embodiments, when the user uses the second operation to control the UAV to fly in the moving-away tracking flight mode, the UAV may determine a line connecting a location of the target object and a location of the UAV. The UAV may fly in a direction moving away from the target object along the line. As a result, the tracking angle and photographing angle of the UAV relative to the target object may be maintained constant, and near-to-far photographing may be realized.

Alternatively or additionally, in some embodiments, controlling the UAV to track the target object while flying in the moving-away tracking flight mode may include: controlling the UAV to fly for a first distance in a direction moving away from the target object. The first distance may be N times of a distance reduced between the two touching points, where N is a positive number.

In some embodiments, due to the opposite moving of the touching points, the distance between two touching points may be reduced for D1. Correspondingly, the disclosed method may include controlling the distance that the UAV moves away from the target object based on the distance D1 reduced between the two touching points. For example, the distance reduced and the distance the UAV moves away from the target object may form a mapping relationship. In some embodiments, when the distance reduced is D1, the distance that the UAV flies away from the target object may be determined to be N*D1, where N may be pre-set or may be set or selected by the user.

Alternatively or additionally, in some embodiments, controlling the UAV to track the target object while flying in the moving-away tracking flight mode may include: controlling the UAV to fly in the direction moving away from the target object until a distance between the UAV and the target object is greater than or equal to a second predetermined distance.

In some embodiments, due to the opposite moving of the touching points, the distance between two touching points is reduced. Correspondingly, the UAV is controlled to fly in a direction moving away from the target object. When the distance between the UAV and the target object is greater than or equal to the second predetermined distance, the UAV may be controlled to stop flying in the direction moving away from the target object. In some embodiments, the second predetermined distance may be the maximum distance between the user and the UAV, or may be set by the user. In some embodiments, the second predetermined distance may be determined based on the size of the target object in the image to be captured.

Alternatively or additionally, in some embodiments, controlling the UAV to track the target object while flying in the moving-away tracking flight mode may include: controlling the UAV to fly in the direction moving away from the target object until a proportion that the target object occupies the interactive interface or the image to be captured reaches a first predetermined proportion (e.g., greater than or equal to the first predetermined proportion).

In some embodiments, due to the opposite moving of the touching points, the distance between two touching points is reduced. Correspondingly, the UAV may be controlled to fly in a direction moving away from the target object. As a result, the proportion that the target object occupies the interactive interface or the image to be captured becomes smaller and smaller. When the proportion that the object imaged by the imaging device occupies the interactive interface or the image to be captured becomes the first predetermined proportion, the UAV may be controlled to stop flying in the direction moving away from the target object. In some embodiments, the first predetermine proportion may be set by the user.

Alternatively or additionally, in some embodiments, the sub-flight mode of the tracking flight mode is a moving-closer tracking flight mode. The moving-closer tracking flight mode may be configured to instruct the UAV to fly in a direction moving closer to the target object. In some embodiments, controlling the UAV to track the target object while flying in the moving-closer tracking flight mode may include: based on the control amount generated by the second operation, controlling the UAV to track the target object while flying in the moving-closer tracking flight mode.

In some embodiments, when the sub-flight mode of the tracking flight mode is the moving-closer tracking flight mode, i.e., when the second operation triggers the moving-closer tracking flight mode, as shown in FIG. 7, in the moving-closer tracking flight mode, the UAV tracks the target object while flying in the moving-closer tracking flight mode. When the user performs the second operation on the interactive interface, and when the sub-flight mode triggered by the second operation is the moving-closer tracking flight mode, the control device may convert the second operation into a control amount. The control device may transmit the control amount to the UAV. After receiving the control amount, the UAV may perform various controls based on the control amount, such that the distance between the UAV and the target object is reduced while tracking the target object. As shown in FIG. 7, the disclosed method may also include adjusting the aircraft head of the UAV or the gimbal, such that the imaging device of the UAV faces and focuses on the target object.

Alternatively or additionally, in some embodiments, the second operation may include a two-touching-point operation and a moving-away operation of at least one touching point.

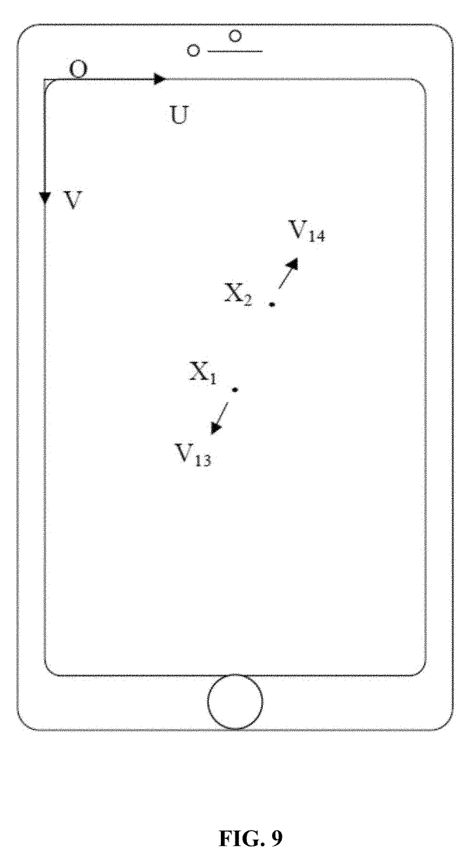

In some embodiments, when the second operation includes a two-touching-point operation and a moving-away operation of at least one touching point, the user uses at least one finger to press or touch the interactive interface, and moves at least one finger away from the other finger(s) while maintaining the pressing or touching. As shown in FIG. 9, in the interactive interface of the control device, the user may press or touch the interactive interface using two fingers to form two touching points (X₁, X₂). When the fingers move away from each other, the touching points also move away from each other (as shown in V₁₃ and V₁₄ shown in FIG. 9). The control device may generate a control amount, and transmit the control amount to the UAV. Based on the control amount, the UAV may fly in a direction moving closer to the target object (V10 shown in FIG. 7).

Alternatively or additionally, in some embodiments, the moving-closer tracking flight mode may be configured to instruct the UAV to fly in a direction moving closer to the target object along a line connecting the UAV and the target object.

In some embodiments, when the user uses the second operation to control the UAV to fly in the moving-closer tracking flight mode, the UAV may determine a line connecting a location of the UAV and a location of the target object. The UAV may fly along the line, moving closer to the target object. As a result, the tracking angle and photographing angle of the UAV relative to the target object may be maintained constant. Photographing from far to near may be realized.

Alternatively or additionally, in some embodiments, controlling the UAV to track the target object while flying in the moving-closer tracking flight mode may include: controlling the UAV to fly in the direction moving closer to the target object for a second distance. The second distance may be M times a distance increased between the two touching points, where M may be a positive number.

In some embodiments, when the two touching points move away from each other, the distance between the two touching points may be increased by D2. Correspondingly, the distance the UAV moves closer to the target object may be controlled based on the distance D2 increased between the two touching points. For example, the distance increased and the distance the UAV moves closer to the target object may form a mapping relationship. For example, when the distance increased is D2, the distance the UAV is controlled to move closer to the target object may be M*D2, where M may be pre-set or may be set by the user.

Alternatively or additionally, in some embodiments, controlling the UAV to track the target object while flying in the moving-closer tracking flight mode may include: controlling the UAV to fly in the direction moving closer to the target object until the distance between the UAV and the target object becomes smaller than or equal to a third predetermined distance.

In some embodiments, when the touching points move away from each other, the distance between the two touching points is increased. Correspondingly, the UAV may be controlled to fly in a direction moving closer to the target object. When the distance between the UAV and the target object becomes smaller than or equal to the third predetermined distance, the UAV may be controlled to stop flying in the direction moving closer to the target object. In some embodiments, the third predetermined distance may be the minimum distance between the user and the UAV, or may be set by the user, or may be determined based on a size of the target object in the image to be captured.

Alternatively or additionally, in some embodiments, controlling the UAV to track the target object while flying in the moving-closer tracking flight mode may include: controlling the UAV to fly in the direction moving closer to the target object until a proportion that an image of the target object occupies the interactive interface or the image to be captured reaches a second predetermined proportion (e.g., greater than or equal to the second predetermined proportion).

In some embodiments, when the touching points move away from each other, the distance between the two touching points is increased. Correspondingly, the UAV may be controlled to fly in a direction moving closer to the target object. As a result, the occupying scope or proportion that the target object occupies the image to be captured increases. When the proportion that the image of the target object captured by the imaging device of the UAV occupies the interactive interface (the display interface) or the image to be captured reaches the second predetermined proportion (e.g., greater than or equal to the second predetermined proportion), the UAV may be controlled to stop flying in the direction moving closer to the target object. In some embodiments, the second predetermined proportion may be set by the user.

Alternatively or additionally, in some embodiments, the control amount generated by the second operation may be used to control at least one of a flight velocity, a flight direction, a flight distance, or an acceleration of the UAV.

In some embodiments, in the tracking flight mode, the control amount generated by the second operation may be used to control the UAV to change the location of the UAV in the air. The second operation may control various motion parameters of the UAV, thereby controlling at least one of the flight direction, flight velocity, flight distance, or flight acceleration.

Alternatively or additionally, in some embodiments, the control amount may be determined or obtained based on one or more of a moving distance, a moving direction, a moving velocity, a moving acceleration of at least one touching point.

In some embodiments, when the touching point moves along with the finger of the user, the control device may generate a corresponding control amount. The control amount may be calculated based on the moving distance of the touching point. For example, in FIG. 4, when the finger moves, the distance between locations of the finger before and after movement may be converted into the control amount. In some embodiments, the control amount may be converted from a moving velocity of the finger. In the horizontally circling tracking flight mode and the vertically circling tracking flight mode, when the movement of the UAV is controlled based on a moving direction of at least one touching point, the moving direction of the at least one touching point may be converted into the control amount. In the horizontally circling tracking flight mode and the vertically circling tracking flight mode, when there are multiple touching points, a center point of the multiple touching points may be used as the effective touching point for calculating the control amount.

Alternatively or additionally, in some embodiments, controlling the UAV to track the target object while flying in the sub-flight mode of the tracking flight mode may include: controlling the UAV to track the target object while flying in the sub-flight mode of the tracking flight mode until the second operation stops or fails.

In some embodiments, when the user performs the second operation, the control device may calculate the control amount corresponding to the second operation. When the second operation stops, the control device stops calculating the control amount. For example, in FIG. 4, when the finger of the user stops moving on the interactive interface, the second operation may be regarded as being stopped. The control device also stops generating the control amount. In some embodiments, when the operation of the user fails, the control device may also stop generating the control amount. For example, in FIG. 5, when the gimbal that carries the imaging device reaches a limit position, even when the second operation continues, the control device may regard the second operation as having failed. Thus, the control device does not generate the corresponding control amount.

In some embodiments, any two or more of vertical circling tracking flight mode, moving-away tracking flight mode, moving-closer tracking flight mode, and horizontally circling tracking flight mode may be combined. In other words, the second operation may realize two or more of the vertically circling tracking flight mode, moving-away tracking flight mode, moving-closer tracking flight mode, and horizontally circling tracking flight mode. For example, when the second operation includes a two-touching-point operation, and when the two touching points move away from each other downwardly, the UAV may move closer to the photographing object while flying in a direction moving closer to the ground. Second operations corresponding to the vertically circling tracking flight mode, moving-away tracking flight mode, moving-closer tracking flight mode, and horizontally circling tracking flight mode may be combined to realize multiple tracking flight effects.

Alternatively or additionally, in some embodiments, the sub-flight mode of the tracking flight mode may be an image composition adjusting tracking flight mode. Controlling the UAV to track the target object while flying in the sub-flight mode of the tracking flight mode may include: based on the second operation, determining a specified scope and a target image that includes the target object in the image to be captured; and controlling the UAV to fly in a direction moving closer to the target object until the target image reaches a predetermined scope.

In some embodiments, based on the second operation, a target image having a specified scope and including the target object may be determined in the image to be captured. The UAV may be controlled to fly in a direction moving closer to the target object. Correspondingly, as the UAV moves closer to the target object, the proportion that the target image occupies the image to be captured or the interactive interface increases. When the scope of the target image reaches a predetermined scope in the image to be captured, the UAV may be controlled to stop flying in the direction moving closer to the target object. Thus, the user may select a large, medium, or small size of the target image of the target object occupying the image to be captured, or select a proportion. The UAV may automatically fly to a photographing location, and compose an image that meets the user's expectation or selection. Accordingly, the disclosed method eliminates the manual operations of the UAV that are otherwise required in a conventional UAV control method for adjusting the location of the UAV to compose an image desired by a user. The disclosed method simplifies the operation process.

Alternatively or additionally, in some embodiments, the predetermined scope is a scope of the image to be captured.

In some embodiments, the interactive interface may display the image to be captured. As the UAV flies in the direction moving closer to the target object, the proportion that the target image of the specific scope displayed in the interactive interface or the image to be captured gradually increases. When the specific scope of the target image reaches the predetermined scope of the image to be captured (e.g., when the interactive interface displays the specific scope of the target object in the full screen), the UAV may be controlled to stop flying in the direction moving closer to the target object. When the user selects the specific scope, the UAV may adjust its position in the air, such that an image having the user selected specific scope occupies the entire image to be captured. No manual operation is required, and the requirement imposed on the user is low.

Alternatively or additionally, in some embodiments, the specific scope is a rectangular scope with equal ratios for the width and height relative to the width and height of the image to be captured or the interactive interface (hereinafter “equal ratio rectangle”).

In some embodiments, the user may perform the second operation on the interactive interface. The second operation may specify the equal ratio rectangle with respect to the image to be captured or the interactive interface. After specifying the equal ratio rectangle, the UAV may fly closer to the target object while tracking the target object.

Alternatively or additionally, in some embodiments, the second operation includes a two-touching-point operation.

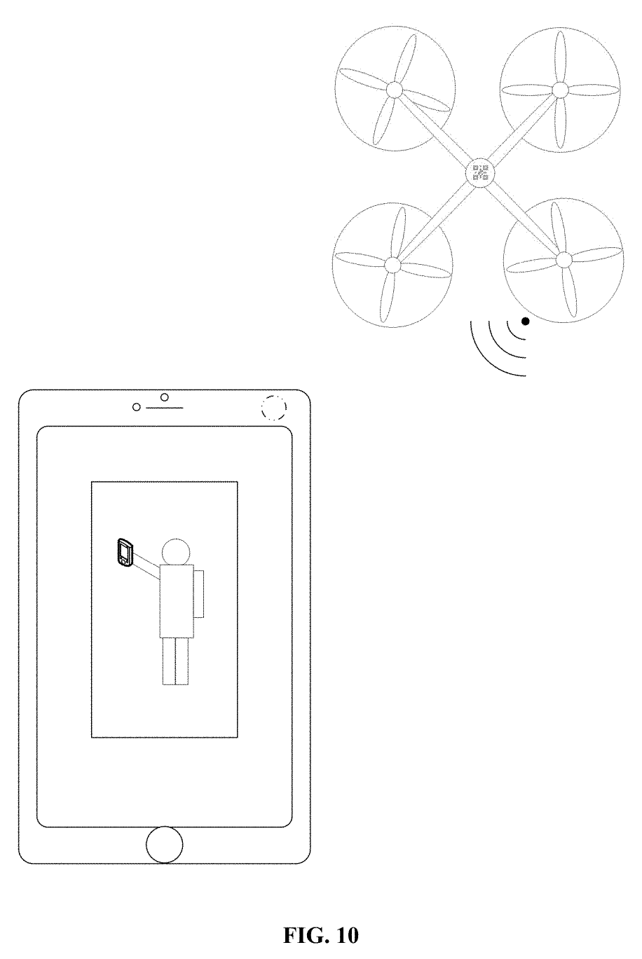

In some embodiments, the second operation may include a two-touching-point operation. In other words, when the user uses two fingers to touch or press the interactive interface, as shown in FIG. 10, two touching points (X₁, X₂) may be formed on the interactive interface. The control device may determine a specified scope base on the touching or pressing of the finger. The specified scope may be a rectangle defined based on the two touching points. The rectangle may have equal ratios for the width and height relative to the width and height of the image to be captured or the interactive interface.

Alternatively or additionally, in some embodiments, locations of the two touching points may be locations of two of the four vertices of the rectangle.

Alternatively or additionally, in some embodiments, a line connecting the two touching points may be a diagonal of the rectangle.

In some embodiments, the UAV may fly according to the flight mode determined based on the first operation. The disclosed method overcomes the advantages of conventional techniques that require multiple manual operations to control the UAV to fly in a selected flight mode, thereby simplifying the operations for selecting a flight mode for the UAV, and increasing the efficiency of controlling the flight of the UAV. In some embodiments, the location of the UAV in the air may be changed based on the second operation, thereby realizing multiple photographing effects through simple operations.

The present disclosure also provides a non-transitory computer readable storage medium configured to store computer codes or instructions. The computer codes or instructions, when executed by a processor, cause the processor to execute all or some of the steps of the control method shown in FIG. 2 for controlling the UAV.

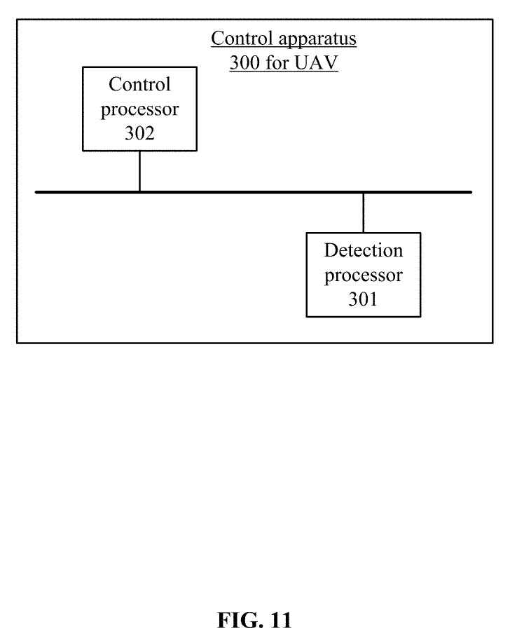

FIG. 11 is a schematic diagram of a control apparatus 300 of the UAV. As shown in FIG. 11, the control apparatus 300 may include a detection processor 301 and a control processor 302. In some embodiments, the detection processor 301 may be configured to detect the first operation on the interactive interface. The control processor 302 may be configured to control the UAV to fly in a flight mode triggered by or determined based on the first operation.

Alternatively or additionally, in some embodiments, when the first operation is a touching-point operation, the flight mode triggered by the first operation may be a touching-point flight mode. The touching-point flight mode may be configured to instruct the UAV to fly in a direction indicated by the touching-point operation in the image to be captured. The control processor 302 may be configured to control the UAV to fly in the touching-point flight mode.

Alternatively or additionally, in some embodiments, when the first operation is a frame-drawing operation, the flight mode triggered by the first operation may be a tracking flight mode. The frame-drawing operation may be used to select the object in the image to be captured as a target object for tracking. The tracking flight mode may be configured to instruct the UAV to fly while tracking the target object. The control processor 302 may be configured to control the UAV to track the target object while flying in the tracking flight mode.

Alternatively or additionally, in some embodiments, the detection processor 301 may be configured to detect a second operation on the interactive interface, after detecting the first operation on the interactive interface. The second operation may be used to determine a sub-flight mode of the tracking flight mode for the UAV. The control processor 302 may be configured to control the UAV to track the target object while flying in the sub-flight mode of the tracking flight mode.

Alternatively or additionally, in some embodiments, the sub-flight mode of the tracking flight mode may be a horizontally circling tracking flight mode. The horizontally circling tracking flight mode may be configured to instruct the UAV to use the target object as a center, maintain a constant distance with the target object, and track the target object while circling the target object in a horizontal plane. The control processor 302 may be configured to control the UAV to track the target object while flying in the horizontally circling tracking flight mode based on a control amount generated by the second operation.

Alternatively or additionally, in some embodiments, the second operation includes at least one touching-point operation and a left-moving operation based on at least one touching point. The left-moving may include moving in a negative axis direction of the U axis in the image coordinate system. The control processor 302 may be configured to control the UAV horizontally circle the target object, using the target object as a center, in a counter-clockwise direction or a clockwise direction, based on the control amount generated by the second operation.

Alternatively or additionally, in some embodiments, the second operation may include at least one touching-point operation and a right-moving operation based on at least one touching point. The right-moving may include moving in the positive axis direction of the U axis in the image coordinate system. The control processor 302 may be configured to control the UAV to horizontally circle the target object, using the target object as a center, in a counter-clockwise direction or a clockwise direction, based on the control amount generated by the second operation.

Alternatively or additionally, in some embodiments, the sub-flight mode of the tracking flight mode may be a vertically circling tracking flight mode. The vertically circling tracking flight mode may be configured to instruct the UAV to use the target object as a center, maintain a constant distance with the target object, and circle around the target object in a vertical plane while tracking the target object. The control processor 302 may be configured to control the UAV to track the target object while flying in the vertically circling tracking flight mode based on the control amount generated by the second operation.

Alternatively or additionally, in some embodiments, the second operation may include at least one touching-point operation and an upward moving operation based on at least one touching point. The upward moving may include moving in a negative axis direction of the V axis in the image coordinate system. The control processor 302 may be configured to control the UAV to circle in a direction moving away from the ground using the target object as a center, based on the control amount generated by the second operation.

Alternatively or additionally, in some embodiments, the second operation may include at least one touching-point operation and a downward moving operation based on at least one touching point. The downward moving may include moving in a positive axis direction of the V axis in the image coordinate system. The control processor 302 may be configured to control the UAV to circle around the target object in a direction moving closer to the ground, based on the control amount generated by the second operation.

Alternatively or additionally, in some embodiments, the control processor 302 may be configured to control the UAV circle-fly in a direction moving away from the ground until the UAV flies to a place right over the target object. Alternatively or additionally, the control processor 302 may be configured to control the UAV to circle-fly in a direction moving closer to the ground until the gimbal of the UAV reaches a limit position. Alternatively or additionally, the control processor 302 may be configured to control the UAV to circle-fly in a direction moving closer to the ground until the distance between the UAV and the ground or an obstacle on the ground is smaller than or equal to a first predetermined distance.

Alternatively or additionally, in some embodiments, the sub-flight mode of the tracking flight mode is a moving-away tracking flight mode. The moving-away tracking flight mode may be configured to instruct the UAV to fly in a direction moving away from the target object. The control processor 302 may be configured to control the UAV to track the target object while flying in the moving-away tracking flight mode based on the control amount generated by the second operation.

Alternatively or additionally, in some embodiments, the second operation may include a two-touching-point operation and an opposite moving of at least one touching point toward the other touching point(s).

Alternatively or additionally, in some embodiments, the moving-away tracking flight mode may be configured to instruct the UAV to fly in a direction moving away from the target object along a line connecting the UAV and the target object.

Alternatively or additionally, in some embodiments, the control processor 302 may be configured to control the UAV in a direction moving away from the target object until the distance between the UAV and the target object is greater than or equal to a second predetermined distance.

Alternatively or additionally, in some embodiments, the control processor 302 may be configured to control the UAV to fly in a direction moving away from the target object until the proportion that an image of the target object occupies the interactive interface or the image to be captured reaches a first predetermined proportion (e.g., greater than or equal to the first predetermined proportion).

Alternatively or additionally, in some embodiments, the sub-flight mode of the tracking flight mode is a moving-closer tracking flight mode. The moving-closer tracking flight mode may be configured to instruct the UAV to fly in a direction moving closer to the target object. The control processor 302 may be configured to control the UAV to track the target object while flying in the moving-closer tracking flight mode based on a control amount generated by the second operation.

Alternatively or additionally, in some embodiments, the second operation may include a two-touching-point operation and a moving-away operation of at least one touching point.

Alternatively or additionally, in some embodiments, the moving-closer tracking flight mode may be configured to instruct the UAV to fly in a direction moving closer to the target object along a line connecting the UAV and the target object.

Alternatively or additionally, in some embodiments, the control processor 302 may be configured to control the UAV to fly in a direction moving closer to the target object until the distance between the UAV and the target object becomes smaller than or equal to a third predetermined distance.

Alternatively or additionally, in some embodiments, the control processor 302 may be configured to control the UAV to fly in a direction moving closer to the target object until the proportion that the image of the target object occupies the interactive interface or the image to be captured reaches a second predetermined proportion (e.g., greater than or equal to the second predetermined proportion).

Alternatively or additionally, in some embodiments, the control amount generated by the second operation may be used to control one or more of a flight velocity, flight direction, flight distance, or acceleration of the UAV.

Alternatively or additionally, in some embodiments, the control amount may be obtained based on one or more of a moving distance, a moving direction, a moving velocity, or a moving acceleration of at least one touching point.

Alternatively or additionally, in some embodiments, the control processor 302 may be configured to control the UAV to track the target object while flying in the sub-flight mode of the tracking flight mode, until the second operation is stopped.

Alternatively or additionally, in some embodiments, the sub-flight mode of the tracking flight mode is an image composition adjusting flight mode. The control processor 302 may be configured to determine a specified scope and a target image that includes the target object in the image to be captured; and control the UAV to fly in a direction moving closer to the target object, until the target image reaches a predetermined scope in the image to be captured.

Alternatively or additionally, in some embodiments, the predetermine scope may be a scope of the image to be captured.

Alternatively or additionally, in some embodiments, the specified scope is a rectangular scope, the width and height of which have equal ratios with respect to the width and height of the image to be captured or the interactive interface.

Alternatively or additionally, in some embodiments, the second operation includes a two-touching-point operation.

Alternatively or additionally, in some embodiments, locations of the two touching points are locations of two vertices of the rectangle.

Alternatively or additionally, in some embodiments, a line connecting the two touching points is the diagonal of the rectangle.

The control apparatus of the present disclosure may be configured to execute the technical solutions of the disclosed methods.

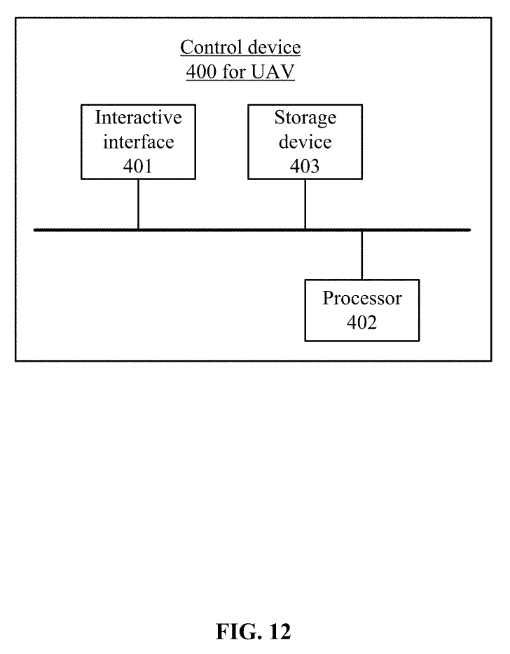

FIG. 12 is a schematic diagram of a control device 400 for a UAV. As shown in FIG. 12, the control device 400 may include an interactive interface 401 and a processor 402. The interactive interface 401 may be connected with the processor 402 through a bus.

The processor 402 may include a central processing unit. The processor 402 may also include other suitable processors, such as a general purpose processor, a digital signal processor (“DSP”), an application specific integrated circuit (“ASIC”), a field-programmable gate array (“FPGA”), or other programmable logic electrical elements, discrete gates, or transistor logic elements, discrete hardware assembly, etc. A general purpose processor may be a microprocessor or any other regular processors.

In some embodiments, the interactive interface 401 may be configured to detect the first operation.

The processor 402 may be configured to determine a flight mode for the UAV based on the first operation, and control the UAV to fly in the flight mode.

Alternatively or additionally, in some embodiments, when the first operation includes a touching-point operation, the flight mode triggered by the first operation may be a pointing flight mode. The pointing flight mode may be configured to instruct the UAV to fly in a direction indicated by the touching-point operation in the image to be captured. The processor 402 may be configured to control the UAV to fly in the pointing flight mode.

Alternatively or additionally, in some embodiments, when the first operation includes a frame-drawing operation, the flight mode triggered by the frame-drawing operation may be a tracking flight mode. The frame-drawing operation may select the object included in the frame drawn in the image to be captured as a target object for tracking. The tracking flight mode may be configured to instruct the UAV to track the target object while flying. The processor 402 may be configured to control the UAV to track the target object while flying in the tracking flight mode.

Alternatively or additionally, in some embodiments, the interactive interface 401 may be configured to detect a second operation after detecting the first operation. The second operation may be used to determine the sub-flight mode of the tracking flight mode of the UAV.

In some embodiments, the processor 402 may be configured to control the UAV to track the target object while flying in the sub-flight mode of the tracking flight mode determined based on the second operation.

Alternatively or additionally, in some embodiments, the sub-flight mode of the tracking flight mode may be a horizontally circling tracking flight mode. The horizontally circling tracking flight mode may be configured to instruct the UAV to use the target object as a center, maintain a constant distance with the target object, and circle the target object in a horizontal plane. The processor 402 may be configured to control the UAV to track the target object while flying in the horizontally circling tracking flight mode based on the control amount generated by the second operation.

Alternatively or additionally, in some embodiments, the second operation may include a touching-point operation and a left-moving operation based on at least one touching point. The left-moving may include moving in a negative axis direction of the U axis in the image coordinate system. The processor 402 may be configured to control the UAV to circle the target object using the target object as a center in a counter-clockwise direction or a clockwise direction, based on the control amount generated by the second operation.

Alternatively or additionally, in some embodiments, the second operation may include at least one touching-point operation and a right-moving operation based on at least one touching point. The right-moving may include moving in a positive axis direction of the U axis in the image coordinate system. The processor 402 may be configured to control the UAV to circle the target object using the target object as a center in a counter-clockwise direction or a clockwise direction, based on the control amount generated by the second operation.

Alternatively or additionally, in some embodiments, the sub-flight mode of the tracking flight mode is a vertically circling tracking flight mode. The vertically circling tracking flight mode may be configured to instruct the UAV to use the target object as a center, maintain a constant distance with the target object, and track the target object while circling around the target object in a vertical plane. The processor 402 may be configured to control the UAV to track the target object while flying in the vertically circling tracking flight mode, based on the control amount generated by the second operation.

Alternatively or additionally, in some embodiments, the second operation may include at least one touching-point operation and an upward moving operation based on at least one touching point. The upward moving may include moving in a negative axis direction of the V axis in the image coordinate system.

The processor 402 may be configured to control the UAV to circle around the target object using the target object as a center, while flying in a direction moving away from the ground, based on the control amount generated by the second operation.

Alternatively or additionally, in some embodiments, the second operation may include at least one touching-point operation and a downward moving operation based on at least one touching point. Downward moving may include moving in a positive axis direction of the V axis in the image coordinate system.

The processor 402 may be configured to control the UAV to circle around the target object using the target object as a center, while flying in a direction moving closer to the ground, based on the control amount generated by the second operation.

Alternatively or additionally, in some embodiments, the processor 402 may be configured to control the UAV to circle-fly in a direction moving away from the ground until the UAV reaches a location right over the target object. In some embodiments, the processor 402 may be configured to control the UAV to circle-fly in a direction moving closer to the ground until the gimbal of the UAV reaches a limit position. In some embodiments, the processor 402 may be configured to control the UAV to circle-fly in a direction moving closer to the ground until a distance between the UAV and the ground or an obstacle on the ground is smaller than or equal to a first predetermined distance.

Alternatively or additionally, in some embodiments, the sub-flight mode of the tracking flight mode is a moving-away tracking flight mode. The moving-away tracking flight mode may be configured to instruct the UAV to fly in a direction moving away from the target object. The processor 402 may be configured to control the UAV to track the target object while flying in the moving-away tracking flight mode based on the control amount generated by the second operation.

Alternatively or additionally, in some embodiments, the second operation may include a two-touching-point operation and an opposite moving operation of at least one touching point with respect to other touching point(s).

Alternatively or additionally, in some embodiments, the moving-away tracking flight mode may be configured to instruct the UAV to fly in a direction moving away from the target object along a line connecting the UAV and the target object.

Alternatively or additionally, in some embodiments, the processor 402 may be configured to control the UAV to fly in a direction moving away from the target object until the distance between the UAV and the target object is greater than or equal to a second predetermined distance.

Alternatively or additionally, in some embodiments, the processor 402 may be configured to control the UAV to fly in a direction moving away from the target object until the proportion that an image of the target object occupies the interactive interface or the image to be captured reaches a first predetermined proportion (e.g., greater than or equal to the first predetermined proportion).

Alternatively or additionally, in some embodiments, the sub-flight mode of the tracking flight mode may be a moving-closer tracking flight mode. The moving-closer tracking flight mode may be configured to instruct the UAV to fly in a direction moving closer to the target object. The processor 402 may be configured to control the UAV to track the target object while flying in the moving-closer tracking flight mode.

Alternatively or additionally, in some embodiments, the second operation may include a two-touching-point operation and an opposite moving operation of at least one touching point with respect to other touching point(s).

Alternatively or additionally, in some embodiments, the moving-closer tracking flight mode may instruct the UAV to fly in a direction moving closer to the target object along a line connecting the UAV and the target object.

Alternatively or additionally, in some embodiments, the processor 402 may be configured to control the UAV to fly in a direction moving closer to the target object until the distance between the UAV and the target object is smaller than or equal to a third predetermined distance.

Alternatively or additionally, in some embodiments, the processor 402 may be configured to control the UAV to fly in a direction moving closer to the target object until the proportion that the image of the target object occupies the interactive interface or the image to be captured reaches a second predetermined proportion (e.g., greater than or equal to the second predetermined proportion).

Alternatively or additionally, in some embodiments, the control amount generated by the second operation may be used to control one or more of a flight velocity, a flight direction, a flight distance, or an acceleration of the UAV.

Alternatively or additionally, in some embodiments, the control amount may be obtained based on one or more of a moving distance, a moving direction, a moving velocity, or a moving acceleration of at least one touching point.

Alternatively or additionally, in some embodiments, the processor 402 may be configured to control the UAV to track the target object while flying in the sub-flight mode of the tracking flight mode until the second operation stops.

Alternatively or additionally, in some embodiments, the sub-flight mode of the tracking flight mode is an image composition adjusting flight mode. The processor 402 may be configured to determine a specified scope and a target image of the target object in the image to be captured; and control the UAV to fly in a direction moving closer to the target object, until the target image reaches a predetermined scope in the image to be captured.

Alternatively or additionally, in some embodiments, the predetermined scope may be the scope of the image to be captured.

Alternatively or additionally, in some embodiments, the specified scope is a rectangular scope, the width and height of which have equal ratios with respect to the width and height of the image to be captured or the interactive interface.

Alternatively or additionally, in some embodiments, the second operation includes a two-touching-point operation.

Alternatively or additionally, in some embodiments, locations of the two touching points are locations of two vertices of the rectangle.

Alternatively or additionally, in some embodiments, a line connecting the two touching points is the diagonal of the rectangle.

Alternatively or additionally, in some embodiments, the control device 400 may further include a storage device 403. The interactive interface 401, the processor 402, and the storage device 403 may be connected with one another through a bus. The storage device 403 may include at least one of a read-only storage device or a random-access storage device. The storage device 403 may provide instructions and/or data to the processor 402. A portion of the storage device 403 may include a non-transitory random-access storage device. The storage device 403 may be used to store computer codes or instructions for executing the disclosed control methods of the UAV. The processor 402 may be configured to retrieve or read the computer codes from the storage device 403 and execute the computer codes to perform the disclosed methods.

The disclosed device may be configured to execute the technical solutions of the disclosed methods.

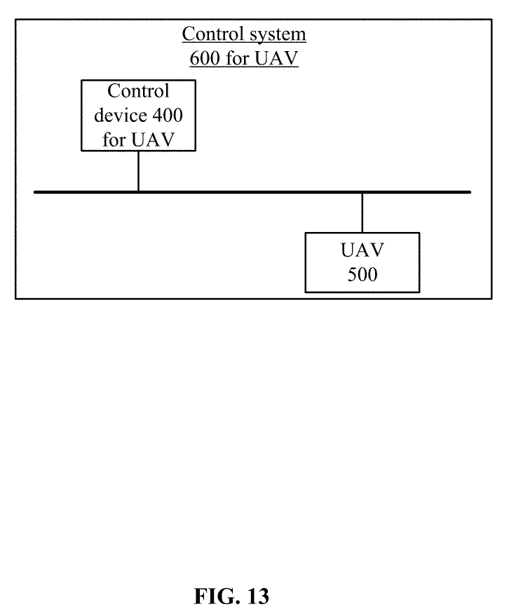

FIG. 13 is a schematic diagram of a system 600 for controlling the UAV. As shown in FIG. 13, the system 600 may include a control device 400 for controlling the UAV and a UAV 500. The control device 400 for controlling the UAV may include a structure shown in FIG. 12, and may be configured to execute the technical solutions of the disclosed methods.

A person having ordinary skill in the art can appreciate, some or all of the steps of the disclosed methods may be implemented using hardware that is related to computer programming codes. The computer program may be stored in a non-transitory computer-readable medium. When the computer program is executed, the steps of the disclosed methods may be performed. The non-transitory computer-readable medium may include any suitable type of media for storing computer programming codes, such as at least one of a read-only memory (“ROM”), a random access memory (“RAM”), a magnetic disk, an optical disk, etc.

Other embodiments of the present disclosure will be apparent to those skilled in the art from consideration of the specification and practice of the embodiments disclosed herein. It is intended that the specification and examples be considered as example only and not to limit the scope of the present disclosure, with a true scope and spirit of the invention being indicated by the following claims. Variations or equivalents derived from the disclosed embodiments also fall within the scope of the present disclosure.

What is claimed is:

1. A method for controlling an unmanned aerial vehicle (“UAV”), comprising:
detecting a first operation on an interactive interface; and
determining a flight mode of the UAV triggered by the first operation, and controlling the UAV to fly in the flight mode.

2. The method of claim 1, wherein
the first operation is a touching-point operation, and the flight mode triggered by the first operation is a pointing flight mode,
the pointing flight mode is configured to instruct the UAV to fly in a direction indicated by the touching-point operation in an image to be captured, and
controlling the UAV to fly in the flight mode comprises controlling the UAV to fly in the pointing flight mode.

3. The method of claim 2, wherein
when the first operation is a frame-drawing operation, the flight mode triggered by the first operation is a tracking flight mode,
the frame-drawing operation is configured to select an object included in a frame drawn in an image to be captured as a target object for tracking,
the tracking flight mode is configured to instruct the UAV to track the target object while flying, and
controlling the UAV to fly in the flight mode comprises controlling the UAV to track the target object while flying in the tracking flight mode.

4. The method of claim 3, wherein detecting the first operation on the interactive interface comprises:
detecting a second operation on the interactive interface, the second operation being configured for determining a sub-flight mode of the tracking flight mode, and
controlling the UAV to track the target object while flying in the tracking flight mode comprises controlling the UAV to track the target object while flying in the sub-flight mode of the tracking flight mode.

5. The method of claim 4, wherein
the sub-flight mode of the tracking flight mode is a horizontally circling tracking flight mode, the horizontally circling tracking flight mode being configured to instruct the UAV to use the target object as a center, maintain a constant distance with the target object, and track the target object while circling around the target object on a horizontal plane, and
controlling the UAV to track the target object while flying in the sub-flight mode of the tracking flight mode comprises: based on a control amount generated by the second operation, controlling the UAV to track the target object while flying in the horizontally circling tracking mode.

6. The method of claim 4, wherein the sub-flight mode of the tracking flight mode is a vertically circling tracking flight mode, the vertically circling tracking flight mode being configured to instruct the UAV to use the target object as a center, maintain a constant distance with the target object, and track the target object while circling around the target object in a vertical plane, and
controlling the UAV to track the target object while flying in the sub-flight mode of the tracking flight mode comprises: based on a control amount generated by the second operation, controlling the UAV to track the target object while flying in the vertically circling tracking mode.

7. The method of claim 4, wherein
the sub-flight mode of the tracking flight mode is a moving-away tracking flight mode, the moving-away tracking flight mode being configured to instruct the UAV to fly in a direction moving away from the target object, and
controlling the UAV to track the target object while flying in the sub-flight monde of the tracking flight mode comprises: based on a control amount generated by the second operation, controlling the UAV to track the target object while flying in the moving-away tracking flight mode.

8. The method of claim 4, wherein
the sub-flight mode of the tracking flight mode is a moving-closer tracking flight mode, the moving-closer tracking flight mode being configured to instruct the UAV to fly in a direction moving closer to the target object, and
controlling the UAV to track the target object while flying in the moving-closer tracking flight mode comprises: based on a control amount generated by the second operation, controlling the UAV to track the target object while flying in the moving-closer tracking flight mode.

9. The method of claim 4, wherein
the sub-flight mode of the tracking flight mode is an image composition adjusting flight mode, and
controlling the UAV to track the target object while flying in the sub-flight mode of the tracking flight mode comprises:
determining a specified scope and a target image including the target object in an image to be captured based on the second operation; and
controlling the UAV to fly in a direction moving closer to the target object, until the target image reaches a predetermined scope in the image to be captured.

10. The method of claim 9, the predetermined scope is a scope of the image to be captured.

11. A device for an unmanned aerial vehicle (“UAV”), comprising:
an interactive interface configured to detect a first operation; and
a processor configured to determine a flight mode of the UAV triggered by the first operation and to control the UAV to fly in the flight mode.

12. The device of claim 11, wherein
the first operation is a touching-point operation,
the flight mode triggered by the first operation is a pointing flight mode configured to instruct the UAV to fly in a direction indicated by the touching-point operation in an image to be captured, and
the processor is configured to control the UAV to fly in the pointing flight mode.

13. The device of claim 11, wherein
when the first operation is a frame-drawing operation, the flight mode triggered by the first operation is a tracking flight mode,
the frame-drawing operation is configured to select an object included in a frame drawn in the image to be captured as a target object for tracking,
the tracking flight mode is configured to instruct the UAV to track the target object while flying, and
the processor is configured to control the UAV to track the target object while flying in the tracking flight mode.

14. The device of claim 13, wherein
the interactive interface is configured to detect a second operation after detecting the first operation, the second operation being configured for determining a sub-flight mode of the tracking flight mode, and
the processor is configured to control the UAV to track the target object while flying in the sub-flight mode of the tracking flight mode determined based on the second operation.

15. The device of claim 14, wherein
the sub-flight mode of the tracking flight mode is a horizontally circling tracking flight mode, the horizontally circling tracking flight mode being configured to instruct the UAV to use the target object as a center, maintain a constant distance with the target object, and track the target object while circling the target object in a horizontal plane, and
the processor is configured to control the UAV to track the target object while flying in the horizontally circling tracking flight mode based on a control amount generated by the second operation.

16. The device of claim 12, wherein
the sub-flight mode of the tracking flight mode is a vertically circling tracking flight mode,
the vertically circling tracking flight mode is configured to instruct the UAV to use the target object as a center, maintain a constant distance with the target object, and track the target object while circling around the target object in a vertical plane, and
the processor is configured to control the UAV to track the target object while flying in the vertically circling tracking flight mode based on a control amount generated by the second operation.

17. The device of claim 14, wherein
the sub-flight mode of the tracking flight mode is a moving-away tracking flight mode,
the moving-away tracking flight mode is configured to instruct the UAV to fly in a direction moving away from the target object, and
the processor is configured to control the UAV to track the target object while flying in the moving-away tracking flight mode, based on a control amount generated by the second operation.

18. The device of claim 14, wherein
the sub-flight mode of the tracking flight mode is a moving-closer tracking flight mode,
the moving-closer tracking flight mode is configured to instruct the UAV to fly in a direction moving away from the target object, and
the processor is configured to control the UAV to track the target object while flying in the moving-closer tracking flight mode, based on a control amount generated by the second operation.

19. The device of claim 14, wherein
the sub-flight mode of the tracking flight mode is an image composition adjusting flight mode, and
the processor is configured to:
determine a specified scope and a target image of the target object in an image to be captured based on the second operation; and
control the UAV to fly in a direction moving closer to the target object until the target image of the target object reaches a predetermined scope in the image to be captured.

20. The device of claim 19, wherein the predetermined scope is a scope of the image to be captured.
